(19) United States
(12) Patent Application Publication
(10) Pub. No.: US 2014/0174173 A1
(43) Pub. Date: Jun. 26, 2014

(54) ANALOG CONDUCTIVE LIQUID LEVEL SENSOR

(71) Applicant: Edward R. Chamberlin, Loveland, OH (US)

(72) Inventor: Edward R. Chamberlin, Loveland, OH (US)

(21) Appl. No.: 14/072,965

(22) Filed: Nov. 6, 2013

Related U.S. Application Data
(60) Provisional application No. 61/725,553, filed on Nov. 13, 2012.

(51) Int. Cl. G01F 23/24

(52) U.S. Cl. CPC G01F 23/24
USPC 73/304 R

(57) ABSTRACT

An analog conductive liquid level sensor for conductive liquids having three probes. The invention provides an analog output in proportion to the level or volume of the fluid. Triangular shaped probes are closer together at the top than at the bottom with the respective triangular apexes at the bottom resulting in a nearly linear output voltage in accordance with the fluid level. The shape of the probes can be changed to proportion the voltage output to the fluid volume of an irregular shaped container. A driver probe near the bottom of the container provides a constant area exposed to the conductive liquid. This probe provides compensation for the variations in fluid conductivity which could introduce errors in the level indication in the container as found with two probe systems.

This application claims benefit of U.S. Provisional Application Ser. No. 61/725,553, filed Nov. 13, 2012, pursuant to 35 USC §119(e).

### FIELD OF THE INVENTION

This invention relates to a liquid level sensor, in particular, the use of a sensor to determine the level of a conductive liquid contained within a vessel.

### BACKGROUND OF THE INVENTION

The use of devices to indicate the level of liquid within a tank or container is well known in the art. The need for knowing whether a liquid in a container is above or below a predetermined level is found in various situations. Typical of those situations where the liquid level must not be permitted to fall below a predetermined level are found in automobile radiators, windshield washer containers or oil in an engine crankcase. The situation where the level can be too high is also common such as found with a recreational vehicle holding tank. Applications for such equipment is also found in industry where frequently the liquid in question is extremely caustic as experienced with chemical reagent reservoirs which must be filled once the chemical has fallen below a particular level in order to keep a process running

A typical float-type of liquid level sensor is disclosed in U.S. Pat. No. 4,386,337, issued to Todd on May 31, 1983. This device is said to be useful for measuring the level of oil in an engine crankcase or transmission fluid in a reservoir. An electrically conductive float disposed within an encapsulator and movably responsive to the liquid level is provided. This movement is then determined. The type of devices used to measure the liquid level also varies substantially. The use of floats, changes in capacitance, optical readers, weight measurements of a liquid are just a few examples of techniques that have been adopted to serve as an indicator of the surface level of a liquid. Some devices have attempted to utilize non-invasive measures, that is, a sensor that is outside of the liquid container.

Representative of this genre is U.S. Pat. No. 4,749,988, issued to Berman et al. on Jun. 7, 1988. The '988 Patent discloses the use of a pair of conductive band electrodes oriented in parallel so that the gap between the electrodes corresponds to the liquid surface level to be measured. The change in capacitance between the electrodes as the liquid level rises and falls serves as the indicator.

U.S. Pat. No. 5,315,872, issued to Moser on May 31, 1994, discloses a liquid level sensor for an electrically conductive liquid. The device requires the use of an electrically conductive material for constructing the tank. Thus, many commonly used containers are unsuitable for use with this device without having substantial additional expense. A voltage source supplies an electrical charge to the tank walls, with ground potential being supplied to the liquid contained therein. The capacitance between the tank walls and liquid varies with the volume of liquid in the tank. The problem of false “full” readings is not discussed.

One of the potentially simplest and least expensive methods for the measurement of the level of a liquid is the use of an electrically conductive liquid as a part of a resistive circuit to ascertain the level. Representative of this genre is found in U.S. Pat. No. 4,277,773, issued to Blatnik on Jul. 7, 1981. This reference discloses a device for measuring the level of cooling liquid within a radiator. The radiator is grounded and an insulated probe is installed in the radiator and measures the level via interconnecting the sensor with the ground to obtain a conductivity measurement. A second sensor is provided to measure a hot liquid level in the same manner.

U.S. Pat. No. 5,719,556, issued to Albin et al. on Feb. 17, 1998, discloses still another variation of a liquid level sensor that utilizes the measurement of resistance as an indicator. Their device is quite complicated and expensive requiring the use of alternating current, an oscillator, and filters as well as other circuitry in order to achieve their objectives.

Therefore, a simple conductive-type of liquid level sensor for conductive fluids such as windshield washing solution that is easy and inexpensive to manufacture; can be attached in a variety of tanks and containers without substantial modification of those tanks; and provide a true indication of the fluid level within its container is needed.

### SUMMARY OF THE INVENTION

It is an aspect of the invention to provide an analog conductive liquid level sensor that can be inexpensively manufactured from durable, readily available parts.

It is another aspect of the invention to provide an analog conductive liquid level sensor that will work whether the liquid that is being measured is grounded or not.

It is still another aspect of the invention to provide an analog conductive liquid level sensor that will show small variations in liquid level even when the liquid container is almost full.

Finally, another aspect of the invention is to provide an analog conductive liquid level sensor that can be used to measure the liquid volume in irregular shaped containers.

The invention is a three probe apparatus that features preferably two triangular shaped probes and a rod-like reference probe. However, other shapes are possible. The probes and associated electronics are configured to provide an analog output voltage in proportion to the fluid volume in the container. The triangular shape of the probes and the fact that these triangular shaped probes are closer together at the top than at the bottom results in a nearly linear voltage output with respective to the fluid level. The probe shape can also be adjusted for irregular shape containers to provide a voltage output that is in proportion to the fluid volume in the container. A third probe near the bottom of the container which is always in contact with the fluid. This third probe provides compensation for the variations in the fluid conductivity which could otherwise skew the level measurements. In other words, a typical two probe system used in a fluid with high conductivity provides an output voltage that indicates the container is fuller than it actually is.

### BRIEF DESCRIPTION OF THE DRAWINGS

FIG. 1 is an illustration of the analog conductive liquid level sensor in accordance with the invention.

FIG. 2 is a detailed illustration of the lower end of the probes of the invention.

FIG. 3 is an illustration of the invention from a side view perspective showing the triangular shape of two of the three probes.

FIG. 4 is an exploded view of the three probes.

### DETAILED DESCRIPTION OF THE INVENTION

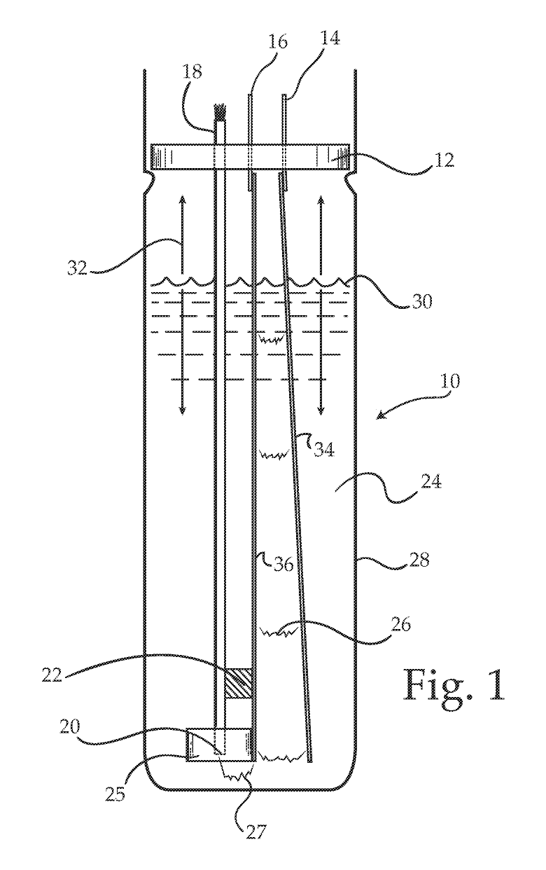

Referring first to FIG. 1, an illustration of the sensor 10 is shown. The invention is an analog conductive liquid level sensor that provides an output voltage that is able to either indicate the liquid level in regular-shaped container or the volume of the liquid in an irregular-shaped container.

Container 28 holds a conductive liquid 24 which is at level 30. As noted above, many elaborate schemes have been developed to determine when liquid 24 goes up or down in container 28 as shown by arrow 32.

None of the referenced prior art is able to inexpensively and reliably indicate the true level of a liquid as it changes in container 28. This is especially true in a situation when small variations occur when a container is nearly full or when container 28 is an irregular shape (not shown).

The sensor 10 has three probes. Driver probe 18 is preferably insulated that has a relatively small tip area 20 that is exposed to the conductive liquid 24. The tip area 20 that is exposed to the fluid 24 does not change with level 30 because tip area 20 is near the bottom of container 28. The tip area 20 of driver probe 18 is also considerably smaller than the areas of probes 34 and 36 thus providing a higher reference resistance than the level resistance. The smaller tip area 20 exposed to fluid 24 will have a higher electrical resistance and will vary only with the conductivity of the fluid 24.

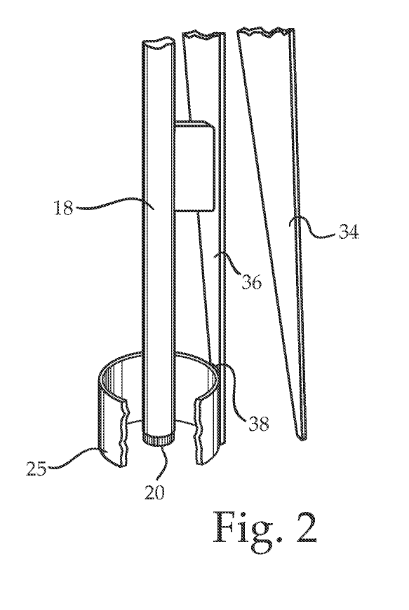

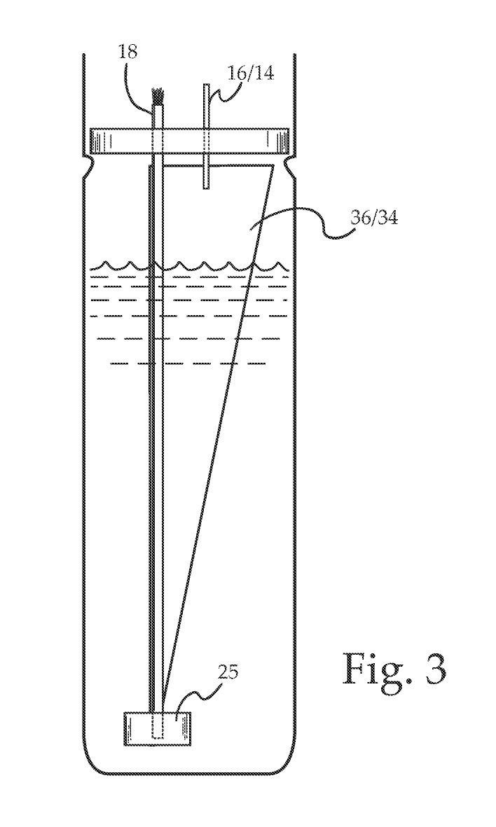

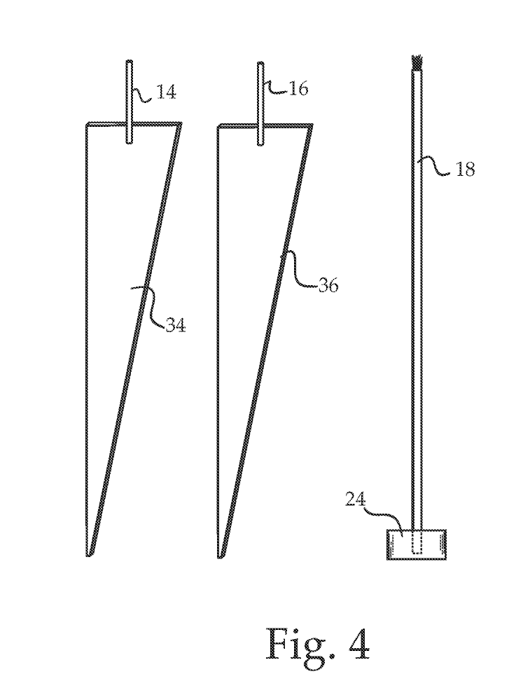

As shown in FIGS. 2-4, sensing probe 36 and ground probe 34 are both preferably triangular-shaped with the distance between the two substantially same sized triangles being greater at the top than at the bottom. Other shapes that provide an area that is substantial greater at the top than at the bottom may also be used in accordance with the application for the probe.

The respective apexes of the triangles are at the bottom of fluid 24. Connectors 16/14 are connected to sensing probe 36 and ground probe 34, respectively. In this manner, the shape and proximity of the probes provides a nearly linear output with respect to the level 30 of liquid 24 in container 28.

An insulating connection 22 is provided between probe 18 and sensing probe 36. A circumferential conducting ring 25 that is electrically connected preferably via solder 38 to sensing probe 36 maintains a uniform distance from tip area 20 of probe 18. As previously noted, the resistance 27 between probe 18 and sensing probe 36 varies with the conductivity of fluid 24 but not with level 30. This design provides a reference resistance 27 to compensate for the conductivity of fluid 24 so that the output signal of sensor 10 indicates liquid level 30.

Driver probe 18 can be powered by alternating or direct current. However, alternating current is preferable to reduce electrolysis. The current runs driver probe 18 through the fluid resistance 27 as indicated to sensing probe 36 and then through fluid resistance 26 to ground probe 34. This arrangement provides a series resistor divider network when sensing probe 36 is the tap between reference resistance 27 (resistance measured between driver probe 18 and sensing probe 36) and fluid level 30 resistance 26 (resistance measured between sensing probe 36 and ground probe 34).

In a resistor divider network, the voltage across the smaller resistance value (level resistance as discussed above) is more proportional to its resistance (fluid level in this case) than the voltage across the higher resistance.

Although the present invention has been described with reference to certain preferred embodiments thereof, other versions are readily apparent to those of ordinary skill in the art. Therefore, the spirit and scope of the appended claims should not be limited to the description of the preferred embodiments contained herein.

What is claimed is:

1. A liquid level sensor for measuring a conductive fluid in a container, said sensor comprising:
a driver probe which is always in contact with the fluid in the container;
a ground probe of predetermined shape;
a sensing probe also of predetermined shape; wherein said probes are able to provide the liquid level in the container if the container is regular-shaped or are able to provide the volume of liquid in the container if the container is irregular-shaped.

2. The liquid level sensor of claim 1 wherein said driver probe has a relatively small area that is exposed to the conductive fluid when compared to areas of exposure of said first probe and said second probe.

3. The liquid level sensor of claim 2 wherein the shape of said ground probe and sensing probe are substantially the same and wherein both have an area of contact with the fluid in the container that is greater at the top of the container than at the bottom of the container.

4. The liquid level sensor of claim 3 wherein said ground probe and said sensing probe are both substantially the same sized triangular shape with the apex of the respective triangular shaped probes being at the bottom of the container and having said probes closer together at the top than at the bottom to provide a nearly linear output with respect to the liquid level or volume in the container.

5. The liquid level sensor of claim 4 further comprising an insulating connection between said driver probe and said sensing probe.

6. The liquid level sensor of claim 5 further comprising a circumferential conducting ring that is electrically connected to said sensing probe in order to maintain a uniform distance from the tip area of said driver probe.

7. The liquid level sensor of claim 6 wherein said driver probe can be driven by either alternating or direct current.

8. The liquid level sensor of claim 6 wherein electrical current provided by said driver probe goes through the fluid from said driver probe to said circumferential conducting ring of said sensing probe provides a reference resistance and, wherein electrical current going through the fluid from said sensing probe to said ground probe provides a level resistance such that the level or volume of fluid in the container is obtained by using a resistor divider network.
